(19) United States
(12) Patent Application Publication
(10) Pub. No.: US 2026/0072502 A1
(43) Pub. Date: Mar. 12, 2026

(54) CONTENT REPRODUCTION APPARATUS AND CONTENT REPRODUCTION METHOD

(71) Applicant: JVCKENWOOD Corporation, Yokohama-shi (JP)

(72) Inventor: Masayuki Nagano, Yokohama-shi (JP)

(21) Appl. No.: 19/390,902

(22) Filed: Nov. 17, 2025

Related U.S. Application Data
(63) Continuation of application No. PCT/JP2024/016922, filed on May 7, 2024.

(30) Foreign Application Priority Data
May 19, 2023 (JP) 2023-082990
May 19, 2023 (JP) 2023-083042

(51) Int. Cl. G06F 3/01

(52) U.S. Cl. CPC G06F 3/013; G06F 3/016; G06F 3/015

(57) ABSTRACT

A content reproduction apparatus includes: a content reproduction unit configured to reproduce a content which is information expressed by at least one of an image, voice, and textual information; a vital data acquisition unit configured to acquire vital data of a user who is viewing and/or listening to the content; a matching degree calculation unit configured to calculate a matching degree between vital data of a character in the content and vital data of the user who is viewing and/or listening to the content; and a matching degree output unit configured to output the calculated matching degree.

### CROSS-REFERENCE TO RELATED APPLICATIONS

This application is a Continuation of PCT International Application No. PCT/JP2024/016922 filed on May 7, 2024 which claims the benefit of priority from Japanese Patent Applications No. 2023-082990 and No. 2023-083042, both filed on May 19, 2023, the entire contents of all of which are incorporated herein by reference.

### FIELD OF THE INVENTION

The present application relates to a content reproduction apparatus and a content reproduction method.

### BACKGROUND OF THE INVENTION

Users who enjoy content, such as electronic books, movies, and dramas, are increasing. It is conceivable that if the content can be provided with a value that allows a new experience, the enjoyment of the content is amplified.

For example, JP 6469875 B2 discloses a cartoon data display method for controlling the speed of feeding pages in an electronic book according to importance given by an author of a novel or a cartoon, or the like.

However, the cartoon data display method described in JP 6469875 B2 described above does not have a mechanism for reproducing related data accompanying a certain scene of a book by a certain apparatus, so that the related data cannot be fed back to a reader who is reading, which fails to utilize the related data.

### SUMMARY OF THE INVENTION

A content reproduction apparatus and a content reproduction method are disclosed.

According to one aspect of the present application, there is provided a content reproduction apparatus comprising: a content reproduction unit configured to reproduce a content which is information expressed by at least one of an image, voice, and textual information; a vital data acquisition unit configured to acquire vital data of a user who is viewing and/or listening to the content; a matching degree calculation unit configured to calculate a matching degree between vital data of a character in the content and vital data of the user who is viewing and/or listening to the content; and

a matching degree output unit configured to output the calculated matching degree.

According to one aspect of the present application, there is provided a content reproduction method comprising: reproducing content which is information expressed by at least one of an image, voice, and textual information; acquiring vital data of a user who is viewing and/or listening to the content; calculating a matching degree between vital data of a character in the content and vital data of the user who is viewing and/or listening to the content; and outputting the calculated degree of matching.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a diagram for explaining an overview of a content reproduction apparatus according to the present application;

FIG. 2 is a diagram illustrating a configuration example of a content reproduction system according to the present application;

FIG. 3 is a diagram illustrating a configuration example of a first embodiment of the content reproduction apparatus according to the present application;

FIG. 4 is a diagram illustrating one example of information stored in a first content storage of the content reproduction apparatus according to the present application;

FIG. 5 is a diagram illustrating a configuration example of a server apparatus according to the present application;

FIG. 6 is a flowchart illustrating a flow of a first embodiment of a content reproduction method according to the present application;

FIG. 7 is a diagram illustrating a configuration example of a second embodiment of the content reproduction apparatus according to the present application;

FIG. 8 is a diagram illustrating one example of information stored in a second content storage of the content reproduction apparatus according to the present application;

FIG. 9 is a flowchart illustrating a flow of a second embodiment of the content reproduction method according to the present application;

FIG. 10 is a diagram illustrating a configuration example of a third embodiment of the content reproduction apparatus according to the present application;

FIG. 11 is a diagram illustrating a configuration example of a fourth embodiment of the content reproduction apparatus according to the present application; and

FIG. 12 is a diagram illustrating a configuration example of a fifth embodiment of the content reproduction apparatus according to the present application.

### DETAILED DESCRIPTION OF THE INVENTION

Hereinafter, embodiments of the present application will be described in detail based on the drawings. Note that the present application is not limited to the embodiments described below.

### Overview of Content Reproduction Apparatus

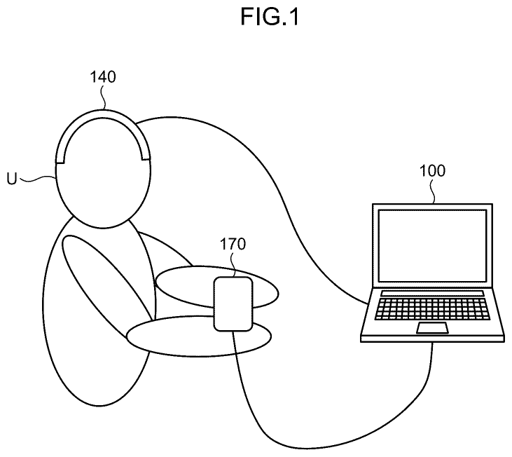

First, an overview of a content reproduction apparatus 100 according to the present application will be described by FIG. 1. FIG. 1 is a diagram for explaining an overview of the content reproduction apparatus according to the present application. As illustrated in FIG. 1, the content reproduction apparatus 100 according to the present application is an information processing apparatus that reproduces content and reproduces vital data of a character in a predetermined scene of the content.

As illustrated in FIG. 1, vital data of a user U is measured by a vital sensor 140 worn on his/her head of the user U, and the vital data of the character in the predetermined scene of the content is reproduced by a vital reproduction unit 170. Note that a disposition of the vital sensor 140 is not limited to the head of the user U.

It should be noted that the aspect of the content reproduction apparatus 100 illustrated in FIG. 1 is one example, and aspects of the content reproduction apparatus 100 according to the present application are not limited to the aspect illustrated in FIG. 1.

### Configuration of Content Reproduction System

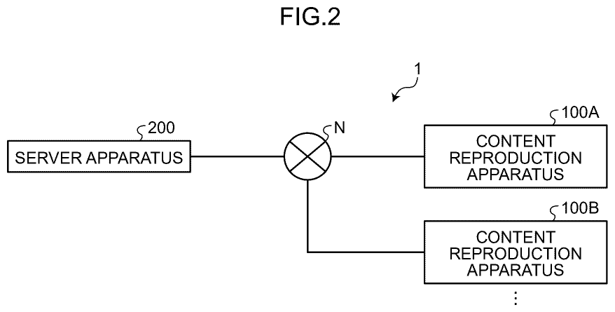

Next, a configuration of a content reproduction system 1 according to the present application will be described using FIG. 2. FIG. 2 is a diagram illustrating a configuration example of the content reproduction system according to the present application.

As illustrated in FIG. 2, the content reproduction system 1 includes the content reproduction apparatus 100 (100A and 100B), a server apparatus 200, and a network N.

Note that, as illustrated in FIG. 2, the content reproduction system 1 may be configured with two or more content reproduction apparatuses 100. Hereinafter, those configurations will be briefly described.

The content reproduction apparatus 100 is an information processing apparatus that reproduces content. The content reproduction apparatus 100 may be, for example, an information processing apparatus such as a smartphone, a tablet terminal, a desktop personal computer (PC), a notebook PC, a mobile phone, and a personal digital assistant (PDA). Since the overview of the content reproduction apparatus 100 is as described above, the description thereof is limited to this extent.

The server apparatus 200 is an information processing apparatus that provides various types of information. The server apparatus 200 provides, for example, content to the content reproduction apparatus 100. The server apparatus 200 may be achieved with, for example, an information processing apparatus such as a PC, a workstation (WS), and a computer including a function of a server.

The network N connects the content reproduction apparatus 100 and the server apparatus 200 to be communicable with each other in a wireless or wired manner. The network N may be achieved with a wireless local area network (LAN) defined in IEEE802.11, a fourth-generation (4G) mobile communication system, a fifth-generation (5G) mobile communication system, or the like.

Note that the content reproduction system 1 functions as one system by exchanging information between the content reproduction apparatus 100 and the server apparatus 200 via the network N.

### Configuration of Content Reproduction Apparatus

### First Embodiment of Content Reproduction Apparatus

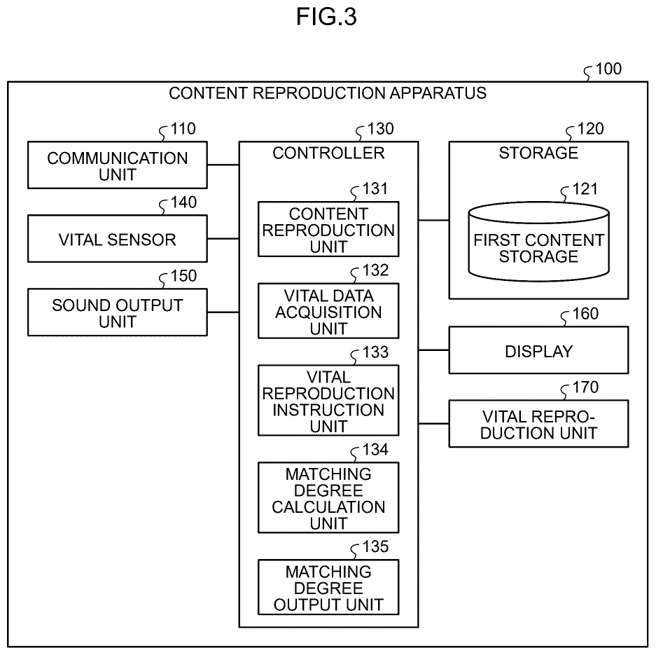

Next, a first embodiment of the content reproduction apparatus 100 according to the present application will be described using FIG. 3. FIG. 3 is a diagram illustrating a configuration example of the first embodiment of the content reproduction apparatus according to the present application. As illustrated in FIG. 3, the first embodiment of the content reproduction apparatus 100 according to the present application includes a communication unit 110, a storage 120, a controller 130, a vital sensor 140, a sound output unit 150, a display 160, and a vital reproduction unit 170. Hereinafter, these configurations will be described in order.

The communication unit 110 connects an inside and an outside of the content reproduction apparatus 100 to be communicable with each other, and transmits and receives information to and from the inside and the outside of the content reproduction apparatus 100 with each other. The communication unit 110 may be achieved with, for example, a wireless local area network (LAN) card, a Wi-Fi (registered trademark) module, a Bluetooth (registered trademark) module, an antenna, or the like. Additionally, the communication unit 110 may be wirelessly connected to the network N, for example, and transmit and receive information to and from the server apparatus 200 with each other.

The storage 120 is a storage that stores various types of information. The storage 120 includes a main storage and an auxiliary storage. The main storage may be achieved with a semiconductor memory element such as a random access memory (RAM), a read only memory (ROM), and a flash memory. In addition, the auxiliary storage may be achieved with, for example, a hard disk, a solid state drive (SSD), an optical disc, or the like.

As illustrated in FIG. 3, the storage 120 includes a first content storage 121.

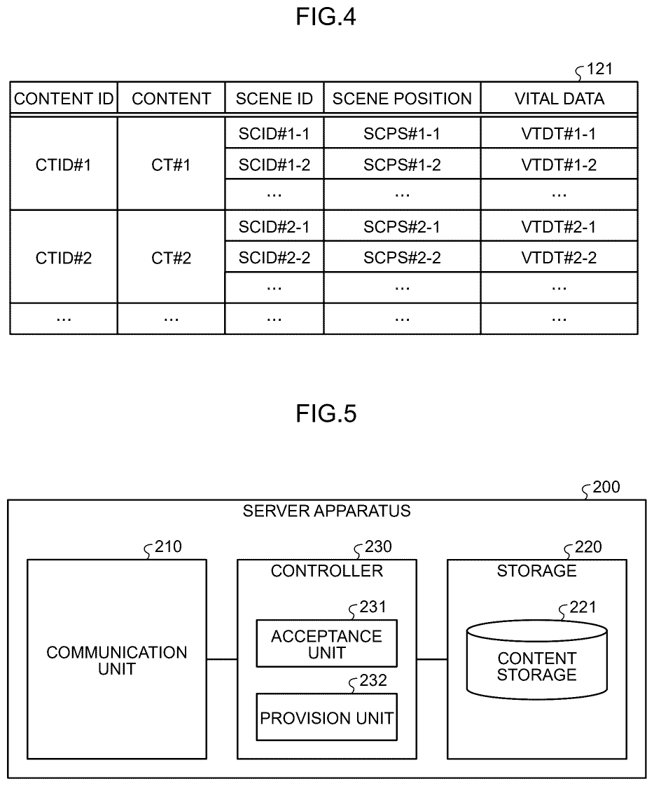

The first content storage 121 stores information related to content. One example of the information stored in the first content storage 121 will be described by FIG. 4. FIG. 4 is a diagram illustrating one example of the information stored in the first content storage of the content reproduction apparatus according to the present application.

In the example illustrated in FIG. 4, the first content storage 121 stores information related to items of “content ID”, “content”, “scene ID”, “scene position”, and “vital data” in association with each other.

The “content ID” is an identifier for identifying content, and is represented by a character string, a number, etc. The “content” is data of the content identified by the “content ID”, and may be, for example, data of a book, a movie, a drama, a concert video, music, etc. Here, the book includes, but is not limited to, electronic books. That is, the “content” is information expressed by at least one of an image, voice, or textual information.

The “scene ID” is an identifier for identifying a scene, in other words, a situation of the content identified by the “content ID”, and is represented by a character string, a number, etc. The “scene position” indicates a position of the scene identified by the “scene ID” in the content identified by the “content ID”, and may be represented by, for example, a ratio to a length of the entire content. Note that, in a case where the content is video information such as a movie and a drama, the “scene position” indicates reproduction time. In addition, in a case where the content is textual information such as a book, the “scene position” indicates a page number and a line number.

The “vital data” is data on a biological state (also referred to as a vital sign such as a pulse, a blood pressure, and a body temperature which indicates that a human being is alive) of a character in the scene identified by the “scene ID” of the content identified by the “content ID”, and the vital reproduction unit 170 expresses the biological state of the character based thereon. Specifically, vital data in a case where the “vital data” is a pulse includes information on a pulse rate etc. The vital data may include information on the number of times the vital data is reproduced during a relevant scene. Thus the “vital data” includes information which indicates that no vital data is reproduced, that is, there is no vital data.

To be more precise, FIG. 4 illustrates an example in which data of content identified by content ID “CTID#1” is stored as “CT#1”, a scene position of a scene identified by scene ID “SCID#1” of that content is “SCPS#1-1”, and vital data to be reproduced by the vital reproduction unit 170 for expressing the biological state of the character in that scene is stored as “VTDT#1-1”.

Note that in the first content storage 121, the information is not limited to the information related to the items of “content ID”, “content”, “scene ID”, “scene position”, and “vital data”, and information related to any other content may be stored.

The controller 130 is a controller that manages and controls the content reproduction apparatus 100. The controller 130 is achieved by a central processing unit (CPU), a micro processing unit (MPU), or the like executing various programs stored in the storage 120 using a RAM as a work area. Alternatively, the controller 130 may be achieved with, for example, an integrated circuit, such as an application specific integrated circuit (ASIC) and a field programmable gate array (FPGA).

As illustrated in FIG. 3, the controller 130 includes a content reproduction unit 131, a vital data acquisition unit 132, a vital reproduction instruction unit 133, a matching degree calculation unit 134, and a matching degree output unit 135. The controller 130 reads programs (software) from the storage 120 and executes the programs to achieve these functions by executing processes therefor. Note that these configurations of the controller 130 may be achieved with electronic circuits. Alternatively, the controller 130 may execute the processes by one CPU, or may include multiple CPUs and execute the processes in parallel by the multiple CPUs. Hereinafter, those configurations will be described in order.

The content reproduction unit 131 reproduces content including at least one of an electronic book, a movie, and a drama. The content reproduction unit 131 reads content from the first content storage 121 and reproduces the read content. For example, the content reproduction unit 131 may cause the sound output unit 150 to output voice of the content and cause the display 160 to display a video of the content to reproduce the content. In a case where the content is video information, the content reproduction unit 131 transmits information on current reproduction time to the vital reproduction instruction unit 133. In a case where the content is an electronic book, the content reproduction unit 131 transmits information on current reproduction page to the vital reproduction instruction unit 133.

The vital data acquisition unit 132 acquires vital data of the user who is viewing and/or listening to the content. Here, in the following description, the viewing of and/or listening to the content also includes reading textual information of a book etc., in addition to viewing of and/or listening to video information of a movie etc. For example, the vital data acquisition unit 132 may acquire, as the vital data, a user's eye potential that is measured by an electrooculography sensor of the vital sensor 140, a direction of a user's line of sight that is measured by a line-of-sight detection camera, a user's electrodermal activity state that is measured by an electrodermal activity sensor, a pulse wave signal that is measured by a pulse wave sensor, a respiratory rate that is calculated from the pulse wave signal, a brain wave that is measured by a electroencephalograph, etc. Note that details of the vital sensor 140 will be described later.

The vital reproduction instruction unit 133 identifies a scene of the content that the user is viewing and/or listening to, and instructs reproduction of vital data of the character in the identified scene. For example, in a case where the content is video information, the vital reproduction instruction unit 133 identifies, as a scene that the user is viewing and/or listening to, the scene at the current reproduction time that is acquired from the content reproduction unit 131. For example, in a case where the content is an electronic book, the vital reproduction instruction unit 133 identifies the current reproduction page number that is acquired from the content reproduction unit 131, as a page that the user is viewing and/or listening to, and, for example, estimates a line that the user is viewing and/or listening to based on the user's line-of-sight direction that is acquired from the vital sensor 140, to identify the scene that the user is viewing and/or listening to. The vital reproduction instruction unit 133 instructs the vital reproduction unit 170 to reproduce the vital data of the character in the identified scene. As described above, the first content storage 121 stores the vital data of the character for each scene in the content. Thus, when a predetermined scene is about to be reached in the content reproduced by the content reproduction unit 131, the vital reproduction instruction unit 133 reads, from the first content storage 121, the vital data of the character in the predetermined scene of the content reproduced, and instructs the vital reproduction unit 170 to reproduce the vital data.

In the information on the content illustrated in FIG. 4, the number of characters corresponding to the vital data to be reproduced in each scene is one. However, the present application is not limited thereto. The information on the content may include pieces of vital data corresponding to multiple characters for one scene ID. For example, in a case where the content is video information, the vital reproduction instruction unit 133 may identify a character that the user is gazing at based on the user's line-of-sight direction that is acquired from the vital sensor 140 etc., and instruct reproduction of the vital data corresponding to the identified character.

Here, in a case where the content is an electronic book, in order to identify a line number corresponding to a scene that the user is viewing and/or listening to, estimation has to be performed from the user's line of sight etc. Depending on the configuration of the vital sensor 140, a case is conceivable in which the user's line of sight cannot be sensed. In view of this, the configuration may be such that a column of “priority” composed of information of “yes” and “no” is added to the information on the content illustrated in FIG. 4, and the vital data is reproduced when the information on the priority of a relevant scene ID is “yes” even if the line of sight cannot be sensed.

The vital reproduction instruction unit 133 corrects the vital data of the character based on a matching degree which is described later and the vital data of the user, and then instructs the vital reproduction unit 170 to reproduce the corrected vital data. Specifically, for example, the vital reproduction instruction unit 133 instructs the reproduction of the vital data of the character, the vital data being corrected based on the matching degree in a direction that brings the vital data of the character close to the vital data of the user. For example, it is assumed that a matching degree calculated by the matching degree calculation unit 134, which is described later, is 80%. In this case, the vital reproduction instruction unit 133 instructs the reproduction of the vital data of the character, the vital data being corrected in a direction that brings the vital data of the character close to the vital data of the user by a data distance of 20%. In other words, the vital reproduction instruction unit 133 makes a correction so as to align 20% of the vital data of the character that does not match the vital data of the user with the vital data of the user. Specifically, reproduction may be instructed in which the vital data obtained by multiplying the vital data of the character by a coefficient for correction to a direction that brings the vital data of the character close to the vital data of the user by a data distance of 20%.

The vital reproduction instruction unit 133 instructs the vital reproduction unit 170 which is a vibration device that outputs vibration to reproduce the vital data as vibration. In this case, the vibration device is driven based on the vital data stored in the first content storage 121, for example, such that the vital reproduction unit 170 expresses, by vibration, a state of beating of the heart (fast and slow, strong and weak, or the like of the pulse) of the character. This makes it possible to allow the user to experience the heart-pounding feeling of the character. Alternatively, the vital reproduction instruction unit 133 may drive the vibration device based on vital data indicating the beating of the heart of a person who does not appear in the scene, vital data expressing a foreshadowing of the story, or vital data in a form in which an interpretation about the feeling of the character is altered in the same scene.

The matching degree calculation unit 134 calculates the matching degree between the vital data of the character and the vital data of the user who is viewing and/or listening to the content. For example, the matching degree calculation unit 134 may calculate the matching degree by executing normalization of the vital data, acquired by the vital data acquisition unit 132, of the user who is viewing and/or listening to the content and the vital data of the character in the content, and then calculating the data distance between these pieces of data using a distance function such as a Euclidean distance, a Manhattan distance, and a Chebyshev distance. The normalization of the vital data of the user may be executed after processing such as smoothing processing. The matching degree calculation unit 134 may calculate the matching degree from a correlation value between the vital data of the character and the vital data of the user who is viewing and/or listening to the content. Here, before the content reproduction, the vital data of the user may be acquired in advance by, for example, the vital sensor 140 or the like to be used for the calculation of the matching degree. For example, an average heart rate of the user is acquired before the content reproduction, the vital data, acquired by the vital data acquisition unit 132, of the user who is viewing and/or listening to the content is corrected based on the average heart rate, and then the matching degree is calculated.

Alternatively, the vital reproduction instruction unit 133 may correct the vital data of the character in a direction expected to bring the vital data of the user close to the vital data of the character based on the matching degree, and instruct the reproduction. Specifically, the vital reproduction instruction unit 133 may make a determination of the direction of correction by using a machine learning model. The machine learning model here is configured to output, in response to input of the vital data of the user, the vital data of the character, and the matching degree, a direction in which the vital data of the character has to be corrected in order to bring the vital data of the user and the vital data of the character closer to each other. This machine learning model is trained using training data composed of a pair of input data and training data. The training data of the machine learning model consists of, for example, input data indicating a direction and a degree to correct the vital data for each user in advance, and training data of the vital data to be resulted.

The matching degree output unit 135 outputs the matching degree calculated by the matching degree calculation unit 134. For example, the matching degree output unit 135 may output the matching degree by causing the display 160 to display the calculated matching degree. Alternatively, the matching degree output unit 135 may output the matching degree by causing the sound output unit 150 to output the calculated matching degree as voice. Alternatively, the matching degree output unit 135 may output, as data, the calculated matching degree to an external apparatus (not illustrated) or the like.

The vital sensor 140 measures biological information of the user, in other words, the vital data. The vital sensor 140 is, for example, an electrooculography sensor, and may measure an eye potential of the user as the vital data. Note that the electrooculography sensor is a sensor that measures a potential difference generated between the corneal side and the retinal side of the eyeball. Typically, the corneal side of the human eyeball is positively charged and the retinal side is negatively charged, so that a potential difference is generated between both sides. When the potential difference is measured with electrodes placed on specific positions of the head, for example, the skin around the eye, eye movement or blinking changes the potential difference, so that measuring of the potential difference makes it possible to know the eye movement, that is, the direction of the line of sight.

Alternatively, the vital sensor 140 may be a camera for sensing the line of sight, and may measure the user's line-of-sight direction as the vital data. The camera for sensing the line of sight is a camera that images the user's eye. The camera for sensing the line of sight may include an analysis unit that performs line-of-sight detection by image analysis of the imaging data of the user's eye. For example, the analysis unit of the camera for sensing the line of sight may detect, based on the imaging data of the user's eye, the direction of the line of sight from a positional relation between a moving point (iris outer edge) and a characteristic portion of a face, an eye, etc. (e.g., the inner corner and the outer corner of the eye).

Alternatively, the vital sensor 140 may be an electrodermal activity (EDA) sensor that detects a state of electrical activity of the skin as the vital data of the user. The electrodermal activity sensor measures a state of electrical activity of the skin, the state being caused by sweat secreted from a sweat gland (e.g., eccrine gland) of the skin. The electrodermal activity is broadly divided into skin potential and skin conductance. The skin potential is distinguished into a skin potential level and a skin potential reflex. The skin potential level is a direct current component of the skin potential, and shows a negative high value when the wakefulness level is high, and shows a positive value when the user feels drowsy or relaxes. The skin potential reflex is an alternating current component of the skin potential, and the skin potential reflex frequently occurs when a stimulus such as pain sensation, tactile sensation, auditory sensation, and visual sensation occurs, or when deep breathing, body movement, mental calculation, or thinking is performed.

Alternatively, the vital sensor 140 may be a pulse wave sensor that detects a pulse wave signal as the vital data of the user. The pulse wave sensor is a sensor that captures, as waveforms, changes in volume of a blood vessel occurring when the heart pumps blood. The pulse wave sensor irradiates a living body with infrared light, red light, or light having a green wavelength around 550 nm, and measures light reflected inside the living body by a photodiode or a phototransistor. Since oxygenated hemoglobin exists in the blood of the artery and has a property of absorbing incident light, a pulse wave signal can be obtained by measuring an amount of blood (volume change of the blood vessel) that changes with pulsation of the heart is measured in time series.

Alternatively, the vital sensor 140 may be an electroencephalograph (EEG) that measures brain waves as the vital data of the user. With the electroencephalograph, electrodes that detects biological activity potentials (around 20 μV) generated by activity of nerve cells in the brain are placed on the scalp, signals received by the electrodes are amplified, and the biological activity potentials (brain waves) of the nerve cells in the brain are measured. For example, the electroencephalograph may be achieved with a type in which a conductive gel is disposed between the scalp and the electrodes to reduce the contact resistance between the electrodes and the scalp, a type in which a sponge is provided between the scalp and the electrodes to contain an electrolytic solution in the sponge, a type in which amplifiers are provided internally in the vicinity of the electrodes to receive electrical signals with high input impedance and output the electrical signals with low output impedance, or the like.

The sound output unit 150 outputs a sound according to a control command. The sound output unit 150 may be a speaker, and the speaker converts an electrical signal into a sound with a diaphragm. To be more precise, the speaker vibrates the diaphragm with a predetermined amplitude and frequency based on the control command given by the electrical signal, thereby vibrating the air in contact with the diaphragm and outputting a sound. The sound output unit 150 may output, for example, voice of the content that is displayed on the display 160 by the content reproduction unit 131.

The display 160 displays various types of information for the user. The display 160 displays a video of the content based on the instruction of the content reproduction unit 131, for example. The display 160 may be achieved with, for example, a liquid crystal display, an organic electro luminescence (EL) display, a micro light emitting diode (LED) display, or the like.

The vital reproduction unit 170 reproduces the vital data of the character in the predetermined scene of the content that the user is viewing and/or listening to. The vital reproduction unit 170 may be achieved with, for example, a display device, a voice output device, a vibration device, a heat source unit, a fragrance unit, or the like. The display device is achieved with a liquid crystal display or the like similarly to the display 160, and expresses the biological state indicated by the vital data of the character by video. Similarly to the sound output unit, the voice output device is a speaker and expresses the biological state indicated by the vital data of the character by voice. The vibration device generates vibration by a motor to which an eccentric rotor is attached, an actuator using an inverse piezoelectric effect of a piezoelectric element, or the like, and expresses the biological state indicated by the vital data of the character. The heat source unit includes a Peltier element and the like, and generates heat by electric power to express the body temperature of the character indicated by the vital data. In addition, the fragrance unit emits a fragrance, and expresses the biological state indicated by the vital data of the character in the predetermined scene of the content by smell.

### Configuration of Server Apparatus

Next, a configuration of the server apparatus according to the present application will be described using FIG. 5. FIG. 5 is a diagram illustrating a configuration example of the server apparatus according to the present application. As illustrated in FIG. 5, the server apparatus 200 according to the present application includes a communication unit 210, a storage 220, and a controller 230.

The communication unit 210 is achieved with, for example, a network interface card (NIC), a wireless LAN card, or the like. Additionally, the communication unit 210 is connected to the network N in a wired or wireless manner, and transmits and receives various types of information to and from the content reproduction apparatus 100 via the network N.

The storage 220 is a storage that stores various types of information. The storage 220 includes a main storage and an auxiliary storage. The main storage may be achieved with a semiconductor memory element, such as a RAM, a ROM, and a flash memory. In addition, the auxiliary storage may be achieved with, for example, a hard disk, an SSD, an optical disc, or the like.

As illustrated in FIG. 5, the storage 220 includes a content storage 221.

Note that information stored in the content storage 221 is the same as the information stored in a first content storage 121 of the content reproduction apparatus 100, and thus description thereof is omitted. However, the number of pieces of content stored in each of the content storage 221 and the first content storage 121 may be different.

The controller 230 is achieved by, for example, a CPU, an MPU, or the like executing various programs stored in the server apparatus 200 using a RAM as a work area. In addition, the controller 230 may be achieved with, for example, an integrated circuit, such as an ASIC and an FPGA.

As illustrated in FIG. 5, the controller 230 includes an acceptance unit 231 and a provision unit 232.

The acceptance unit 231 receives a provision request of content. For example, the acceptance unit 231 may cause the display 160 of the content reproduction apparatus 100 to display an acceptance screen for content including a screen for inputting the type of content, the name of the content, the capacity of the content, and the like that are requested by the user U of the content reproduction apparatus 100 and may accept a provision request of the content from the user.

The provision unit 232 provides content based on the provision request of the content. For example, the provision unit 232 reads content corresponding to the provision request of the content from the content storage 221, and provides the read content to the content reproduction apparatus 100 from which the provision request of the content is transmitted.

### Content Reproduction Method

### First Embodiment of Content Reproduction Method

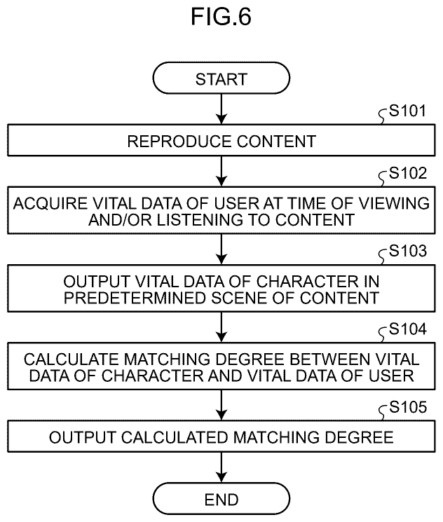

Next, a first embodiment of a content reproduction method according to the present application will be described using FIG. 6. FIG. 6 is a flowchart illustrating a flow of the first embodiment of the content reproduction method according to the present application. The first embodiment of the content reproduction method according to the present application will be described along the flow illustrated in FIG. 6.

First, the content reproduction apparatus 100 reproduces the content (step S101). Next, the content reproduction apparatus 100 acquires the vital data of the user at the time of viewing and/or listening to the content (step S102). Next, the content reproduction apparatus 100 outputs the vital data of the character in the predetermined scene of the content (step S103). Next, the content reproduction apparatus 100 calculates the matching degree between the vital data of the character and the vital data of the user (step S104). After the processing of step S103 and before the processing of step S104, the matching degree may be calculated after waiting for a lapse of a certain period of time, for example, 1 minute. Next, the content reproduction apparatus 100 outputs the calculated matching degree (step S105).

This makes it possible to acquire the vital data of the user who views and/or listens to the content, calculate the matching degree with the vital data of the character in the content, and output the calculated matching degree. Thus, it is possible to provide the content reproduction method capable of offering the user a sense of unity by presenting the user with the vital data of the character in the content that the user is viewing and/or listening to.

### Configuration of Content Reproduction Apparatus

Second embodiment of Content Reproduction Apparatus

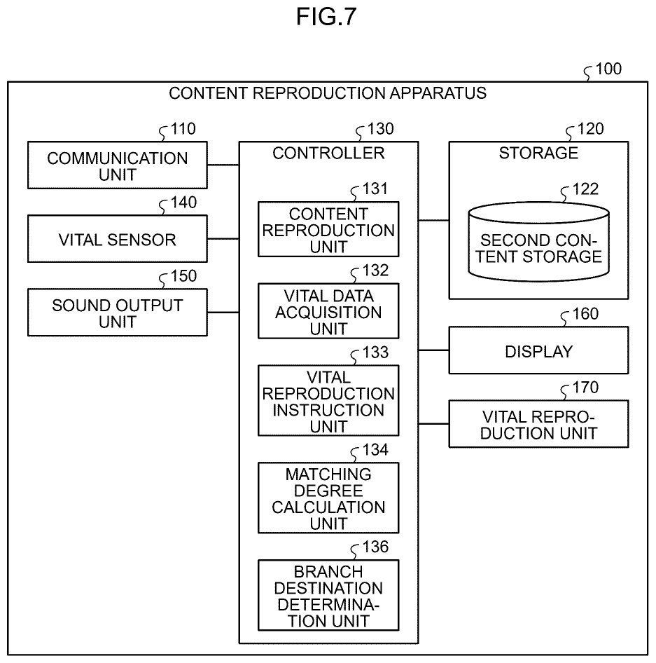

Next, a second embodiment of the content reproduction apparatus 100 according to the present application will be described using FIG. 7. FIG. 7 is a diagram illustrating a configuration example of the second embodiment of the content reproduction apparatus according to the present application. As illustrated in FIG. 7, the second embodiment of the content reproduction apparatus 100 according to the present application includes a communication unit 110, a storage 120, a controller 130, a vital sensor 140, a sound output unit 150, a display 160, and a vital reproduction unit 170.

The configuration of the second embodiment of the content reproduction apparatus 100 is the same as that of the first embodiment of the content reproduction apparatus 100 except for the storage 120 and the controller 130. Hence, in the configuration of the second embodiment of the content reproduction apparatus 100, the description of the same configuration as the configuration of the first embodiment of the content reproduction apparatus 100 will be omitted, and a second content storage 122 of the storage 120 and the controller 130 that are configurations different from the first embodiment of the content reproduction apparatus 100 will be described.

As illustrated in FIG. 7, the storage 120 includes the second content storage 122.

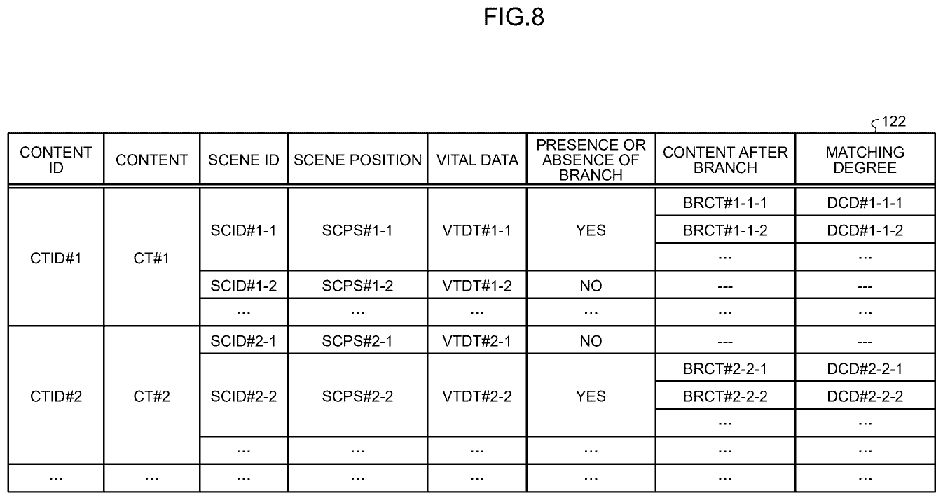

The second content storage 122 stores information related to content. One example of the information stored in the second content storage 122 will be described using FIG. 8. FIG. 8 is a diagram illustrating one example of the information stored in the second content storage 122 of the content reproduction apparatus according to the present application.

In the example illustrated in FIG. 8, the second content storage 122 stores information related to the items of “content ID”, “content”, “scene ID”, “scene position”, “vital data”, “presence or absence of branch”, “content after branch”, and “matching degree” in association with each other. Note that the information other than “presence or absence of branch”, “content after branch”, and “matching degree” is the same as the information stored in the second content storage unit 122. Hence, among the items stored in the first content storage unit 121, and the items of “presence or absence of branch”, “content after branch”, and “matching degree”will be described.

The “presence or absence of branch” is information indicating the presence or absence of a branch of content at a scene identified by the “scene ID” of the content, and is represented by, for example, “yes” or “no”. The “content after branch” is data of content after a branch in a case where there is a branch of content identified by the “content ID” at a scene identified by the “scene ID” of the content. The “matching degree” indicates a threshold or a range of a matching degree between vital data of a user and vital data of a character in the content for a case where “content after branch” as the content after the branch is determined to be reproduced.

To be more precise, FIG. 8 illustrates an example in which content data of content identified by content ID “CTID#1″ is stored as ”CT#1″, a scene position of a scene identified by scene ID “SCID#1” of that content is “SCPS#1-1”, vital data for expressing a biological state of a character in that scene by the vital reproduction unit 170 is stored as “VTDT#1-1”, the presence or absence of a branch in that scene is “yes”, and the content after the branch in that scene is stored as “BRCT#1-1-1” and “BRCT#1-1-2”.

Note that in the second content storage 122, the information is not limited to the information related to the items of “content ID”, “content”, “scene ID”, “scene position”, “vital data”, “presence or absence of branch”, “content after branch”, and “matching degree”, and information related to any other content may be stored.

As illustrated in FIG. 7, the controller 130 includes a content reproduction unit 131, a vital data acquisition unit 132, a vital reproduction instruction unit 133, a matching degree calculation unit 134, and a branch destination determination unit 136. Note that the configuration of the controller 130 of the second embodiment of the content reproduction apparatus 100 is the same as the configuration of the controller 130 of the first embodiment of the content reproduction apparatus 100 except that the matching degree output unit 135 is excluded and the branch destination determination unit 136 is added. Hence, in the configuration of the controller 130 of the second embodiment of the content reproduction apparatus 100, the description of the same configuration as the configuration of the controller 130 of the first embodiment of the content reproduction apparatus 100 will be omitted, and the branch destination determination unit 136 that is a configuration different from the configuration of the controller 130 of the first embodiment of the content reproduction apparatus 100 will be described.

The branch destination determination unit 136 determines a branch destination of the content based on a calculated matching degree. As described above, the “matching degree” is stored in the second content storage 122 of the storage 120 of the second embodiment of the content reproduction apparatus 100, in association with “content after branch”. Concerning the content reproduced by the content reproduction unit 131, when a scene with a branch of the content is reached, the branch destination determination unit 136 refers to the matching degree calculated by the matching degree calculation unit 134, and determines the content after the branch corresponding to the matching degree as the branch destination of the content. Note that, when determining the branch destination of the content, the branch destination determination unit 136 gives an instruction to cause the content reproduction unit 131 to reproduce the content after the branch.

### Content Reproduction Method

### Second Embodiment of Content Reproduction Method

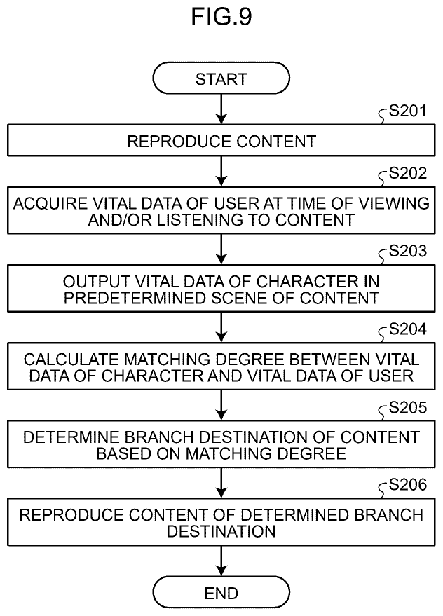

Next, a second embodiment of the content reproduction method according to the present application will be described using FIG. 9. FIG. 9 is a flowchart illustrating a flow of the second embodiment of the content reproduction method according to the present application. The second embodiment of the content reproduction method according to the present application will be described along the flow illustrated in FIG. 9.

First, the content reproduction apparatus 100 reproduces the content (step S201). Next, the content reproduction apparatus 100 acquires the vital data of the user at the time of viewing and/or listening to the content (step S202). Next, the content reproduction apparatus 100 outputs the vital data of the character in a predetermined scene of the content (step S203). Next, the content reproduction apparatus 100 calculates the matching degree between the vital data of the character and the vital data of the user (step S204). Next, the content reproduction apparatus 100 determines the branch destination of the content based on the matching degree (step S205). Next, the content reproduction apparatus 100 reproduces the content of the determined branch destination (step S206).

This makes it possible to acquire the vital data of the user who views and/or listens to the content, calculate the matching degree with the vital data of the character in the content, determine the branch destination of the content based on the calculated matching degree, and reproduce the content after the branch. Thus, it is possible to provide the content reproduction method capable of performing appropriate content branching by performing comparison between the vital data of the user and the vital data of the character.

### Configuration of content reproduction apparatus

Third embodiment of Content Reproduction Apparatus

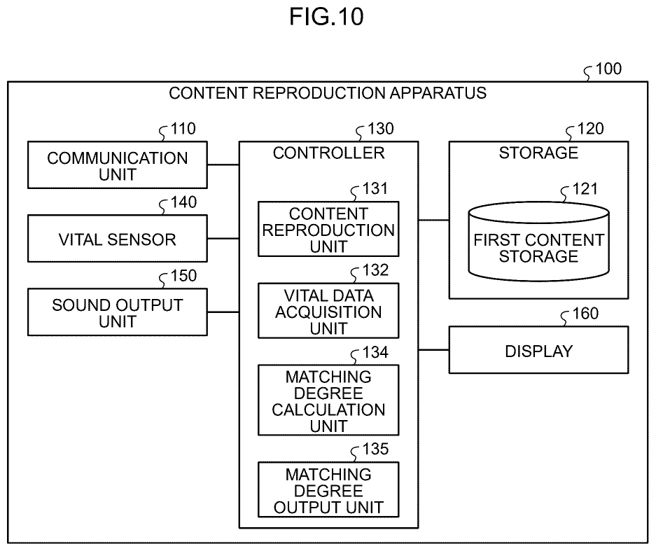

Next, a third embodiment of the content reproduction apparatus 100 according to the present application will be described using FIG. 10. FIG. 10 is a diagram illustrating a configuration example of the third embodiment of the content reproduction apparatus according to the present application. As illustrated in FIG. 10, the third embodiment of the content reproduction apparatus 100 according to the present application includes a communication unit 110, a storage 120, a controller 130, a vital sensor 140, a sound output unit 150, and a display 160.

The third embodiment of the content reproduction apparatus 100 is the same as the first embodiment of the content reproduction apparatus 100 except that the vital reproduction instruction unit 133 of the controller 130 of the first embodiment of the content reproduction apparatus 100 is excluded and the vital reproduction unit 170 is excluded. Hence, the description of the configuration of the third embodiment of the content reproduction apparatus 100 is omitted.

According to the third embodiment of the content reproduction apparatus 100, a simple configuration makes it possible to acquire vital data of a user who views and/or listens to content, calculate a matching degree with vital data of a character in the content, and output the calculated matching degree. Hence, it is possible to detect a sense of unity or a sense of immersion of the user who views and/or listens to the content for the character in the content based on the matching degree.

### Configuration of Content Reproduction Apparatus

### Fourth Embodiment of Content Reproduction Apparatus

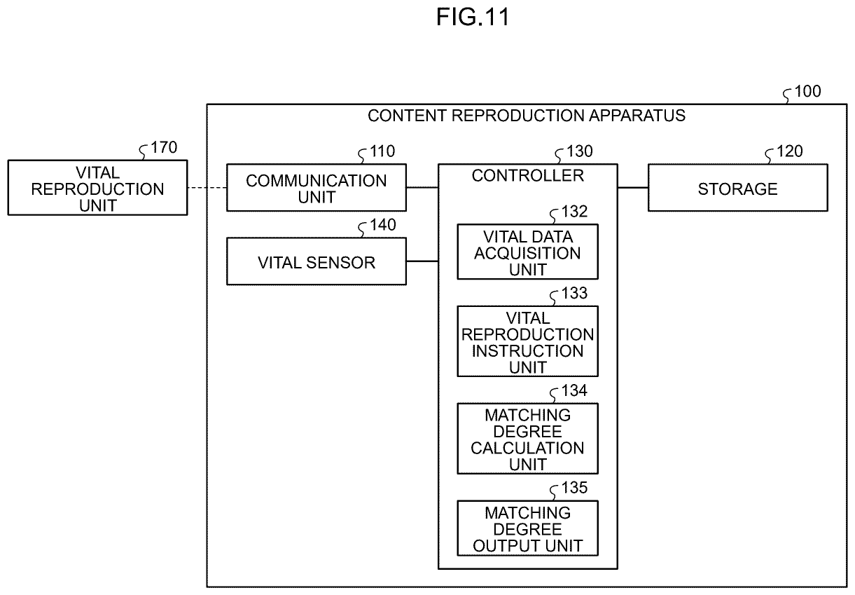

Next, a fourth embodiment of the content reproduction apparatus 100 according to the present application will be described using FIG. 11. FIG. 11 is a diagram illustrating a configuration example of the fourth embodiment of the content reproduction apparatus according to the present application. As illustrated in FIG. 11, the fourth embodiment of the content reproduction apparatus 100 according to the present application includes a communication unit 110, a storage 120, a controller 130, and a vital sensor 140.

The fourth embodiment of the content reproduction apparatus 100 is the same as the first embodiment of the content reproduction apparatus 100 except that the first content storage 121 of the first embodiment of the content reproduction apparatus 100 is excluded from the storage 120, the content reproduction unit 131 is excluded from the controller 130, and the sound output unit 150 and the display 160 are excluded, and a vital reproduction unit 170 is provided outside the content reproduction apparatus 100. Hence, in the configuration of the fourth embodiment of the content reproduction apparatus 100, the description of the same configuration as the configuration of the first embodiment of the content reproduction apparatus 100 will be omitted, and the vital reproduction unit 170 that is a configuration different from the configuration of the first embodiment of the content reproduction apparatus 100 will be described.

The vital reproduction unit 170 according to the fourth embodiment of the content reproduction apparatus 100 is provided outside the content reproduction apparatus 100, includes a Wi-Fi module, Bluetooth, and the like, and is connected to the communication unit 110 to be wirelessly communicable with each other. The vital reproduction unit 170 may perform reproduction by moving, for example, seats in a movie theater forward, backward, leftward, rightward, upward, and downward according to an instruction from a vital reproduction instruction unit 133, to thereby express vital data of a character in a predetermined scene of content. In addition, the vital reproduction unit 170 may express the vital data of the character by mist, scent, strobe light, smoke, vibration, temperature, etc. A plurality of the vital reproduction units 170 according to the fourth embodiment may be connected to one content reproduction apparatus 100. In the case where the plurality of the vital reproduction units 170 are connected, a matching degree calculation unit 134 calculates, for example, the matching degree between the vital data of a person wearing the vital reproduction unit 170 and the vital data of the character respectively.

This makes it possible to acquire the vital data of the users who view and/or listen to the content, and express the vital data of the character in the predetermined scene of the content by the seats in the movie theater. Hence, it is possible to enhance a sense of immersion in movies in movie theaters. Thus, it is possible to provide the content reproduction apparatus 100 capable of offering the users a sense of unity by presenting the users with the vital data of the character in the content that the users are viewing and/or listening to.

### Configuration of Content Reproduction Apparatus

### Fifth Embodiment of Content Reproduction Apparatus

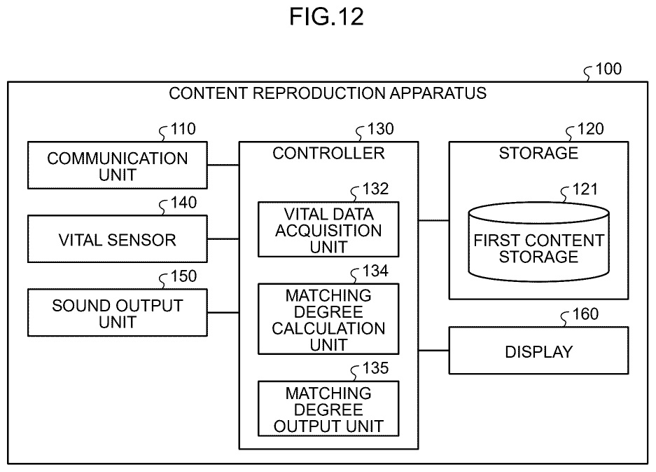

Next, a fifth embodiment of the content reproduction apparatus 100 according to the present application will be described using FIG. 12. FIG. 12 is a diagram illustrating a configuration example of the fifth embodiment of the content reproduction apparatus according to the present application. As illustrated in FIG. 12, the fifth embodiment of the content reproduction apparatus 100 according to the present application includes a communication unit 110, a storage 120, a controller 130, a vital sensor 140, a sound output unit 150, and a display 160.

The fifth embodiment of the content reproduction apparatus 100 is the same as the first embodiment of the content reproduction apparatus 100 except that the content reproduction unit 131 and the vital reproduction instruction unit 133 of the first embodiment of the content reproduction apparatus 100 are excluded from the controller 130 and the vital reproduction unit 170 is excluded. Hence, in the configuration of the fifth embodiment of the content reproduction apparatus 100, the description of the same configuration as the configuration of the first embodiment of the content reproduction apparatus 100 will be omitted, and the configuration different from the configuration of the first embodiment of the content reproduction apparatus 100 will be described.

A matching degree calculation unit 134 according to the fifth embodiment of the content reproduction apparatus 100 calculates a matching degree between vital data of a character and vital data of a user who is viewing and/or listening to content in the same manner as the first embodiment of the content reproduction apparatus 100. However, since the fifth embodiment of the content reproduction apparatus 100 does not include the vital reproduction unit 170, a user U is not aware of the vital data of the character.

This makes it possible to acquire the vital data of the user who views and/or listens to the content, calculate the matching degree with the vital data of the character, and output the calculated matching degree. Thus, it is possible to provide the content reproduction apparatus 100 capable of contributing to a sense of unity by outputting a result of comparison between the vital data of the user and the vital data of the character in the content that the user is viewing and/or listening to.

### Configurations and Effects

A content reproduction apparatus 100 according to the present application includes a content reproduction unit 131 configured to reproduce a content which is information expressed by at least one of an image, voice, and textual information, a vital data acquisition unit 132 configured to acquire vital data of a user who is viewing and/or listening to the content, a matching degree calculation unit 134 configured to calculate a matching degree between vital data of a character in the content and vital data of the user who is viewing and/or listening to the content, and a matching degree output unit 135 configured to output the calculated matching degree.

With this configuration, it is possible to acquire the vital data of the user who views and/or listens to the content, calculate the matching degree with the vital data of the character in the content, and output the calculated matching degree. Thus, it is possible to provide the content reproduction apparatus 100 capable of offering the user a sense of unity by presenting the user with the vital data of the character in the content that the user is viewing and/or listening to.

The content reproduction apparatus 100 according to the present application further includes a vital reproduction instruction unit 133 configured to identify a scene of the content that the user is viewing and/or listening to, and instruct reproduction of the vital data of the character in the content in the identified scene.

With this configuration, it is possible to identify the scene of the content that the user is viewing and/or listening to, and instruct the reproduction of the vital data of the character in the identified scene. Thus, it is possible to provide the content reproduction apparatus 100 capable of offering the user the sense of unity by presenting the user with the vital data of the character in the content that the user is viewing and/or listening to.

The vital reproduction instruction unit 133 of the content reproduction apparatus 100 according to the present application corrects the vital data of the character in the content based on the matching degree and the vital data of the user, and instruct the reproduction of the corrected vital data of the character in the content.

With this configuration, it is possible to reproduce the vital data of the character, the vital data being corrected in a direction that brings the vital data of the character close to the vital data of the user. Hence, it is possible to intensify the sense of unity between the user and the character in consideration of a user's state indicated by the vital data of the user. Thus, it is possible to provide the content reproduction apparatus 100 capable of offering the user the sense of unity by presenting the user with the vital data of the character in the content that the user is viewing and/or listening to.

The vital reproduction instruction unit 133 of the content reproduction apparatus 100 according to the present application instructs a vital reproduction unit 170 which is a vibration device configured to output vibration to reproduce the vital data of the character in the content as vibration.

With this configuration, the vital data of the character can be presented to the user by the vibration device. Hence, a state of beating of the heart (fast and slow, strong and weak, or the like of a pulse) of the character can be appropriately expressed by the vibration. Thus, it is possible to provide the content reproduction apparatus 100 capable of offering the user the sense of unity by presenting the users with the vital data of the character in the content that the user is viewing and/or listening to.

The content reproduction apparatus 100 according to the present application further includes a branch destination determination unit 136 configured to determine a branch destination of the content based on the matching degree.

With this configuration, the branch destination of the content is determined based on the matching degree, and the content of the branch destination can be provided. Thus, it is possible to provide the content reproduction apparatus 100 capable of providing the content branched based on the matching degree after offering the user the sense of unity by presenting the user with the vital data of the character in the content that the user is viewing and/or listening to.

A content reproduction method according to the present application includes reproducing content which is information expressed by at least one of an image, voice, and textual information, acquiring vital data of a user who is viewing and/or listening to the content, calculating a matching degree between vital data of a character in the content and vital data of the user who is viewing and/or listening to the content, and outputting the calculated degree of matching.

With this configuration, it is possible to acquire the vital data of the user who views and/or listens to the content, calculate the matching degree with the vital data of the character in the content, and output the calculated matching degree. Thus, it is possible to provide the content reproduction method capable of offering the user the sense of unity by presenting the user with the vital data of the character in the content that the user is viewing and/or listening to.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

According to the present application, the content reproduction apparatus and the content reproduction method capable of offering the user the sense of unity by presenting the user with the vital data of the character in the content that the user is viewing and/or listening to, can be provided.

The content reproduction apparatus and the content reproduction method according to the present application can be used for a content reproduction apparatus and a content reproduction method capable of offering a user a sense of unity by presenting a user with vital data of a character in a content that a user is viewing and/or listening to.

What is claimed is:

1. A content reproduction apparatus comprising:
a content reproduction unit configured to reproduce a content which is information expressed by at least one of an image, voice, and textual information;
a vital data acquisition unit configured to acquire vital data of a user who is viewing and/or listening to the content;
a matching degree calculation unit configured to calculate a matching degree between vital data of a character in the content and vital data of the user who is viewing and/or listening to the content; and
a matching degree output unit configured to output the calculated matching degree.

2. The content reproduction apparatus according to claim 1, further comprising
a vital reproduction instruction unit configured to:
identify a scene of the content that the user is viewing and/or listening to; and
instruct reproduction of the vital data of the character in the content in the identified scene.

3. The content reproduction apparatus according to claim 2, wherein
the vital reproduction instruction unit is further configured to:
correct the vital data of the character in the content based on the matching degree and the vital data of the user; and
instruct the reproduction of the corrected vital data of the character in the content.

4. The content reproduction apparatus according to claim 2, wherein
the vital reproduction instruction unit is further configured to instruct a vital reproduction unit which is a vibration device configured to output vibration to reproduce the vital data of the character in the content as vibration.

5. The content reproduction apparatus according to claim 1, further comprising
a branch destination determination unit configured to determine a branch destination of the content based on the matching degree.

6. A content reproduction method comprising:
reproducing content which is information expressed by at least one of an image, voice, and textual information;
acquiring vital data of a user who is viewing and/or listening to the content;
calculating a matching degree between vital data of a character in the content and vital data of the user who is viewing and/or listening to the content; and
outputting the calculated degree of matching.
